(19) United States
(12) Patent Application Publication
(10) Pub. No.: US 2004/0007623 A1
(43) Pub. Date: Jan. 15, 2004

(54) System for bar-code/character/graph reader

(76) Inventor: Mark Po-Shaw Huang, Hsih Chi City (TW)

Correspondence Address: BACON & THOMAS, PLLC, 625 SLATERS LANE, FOURTH FLOOR, ALEXANDRIA, VA, 22314

(21) Appl. No.: 10/194,216

(22) Filed: Jul. 15, 2002

(51) Int. Cl. G06K 7/10

(52) U.S. Cl. 235/462.49

(57) ABSTRACT

A bar-code/character/graph reader using an optical input device such as Neuron-Network-Retina (NNR) (or other names are used from time to time: BJT-based Silicon Retina; or Neural Seneor-Silicon Retina) to convert a bar code, character, and graphic image into electrical signals for further processing is disclosed. No dedicated light source such as Light Emitting Diode (LED) is needed, the NNR is using the nature ambient light through a transparent window as light source, and thus achieving power saving purpose, which is crucial for battery operation. Moreover, the NNR can be equipped with the noise removal, black/white enhancement, edge enhancement, image smoothing, and motion extraction capability. Therefore, it can remove possible error causing by shadow, scanning speed difference, dirty image (from a fax copy, for example), tilt angle, etc . . . The output of NNR is fed through a Radio Frequency (RF) transmitter, and then transferred into an RF receiver with a few meters away connecting to a personal computer. The bar-code/character/graph reader is shape as a pen type with NNR located near the tip of said pen. A transparent module and focusing lens is located between the bar-code/character/graph image and the NNR, so that the ambient light will not be blocked and the image can always be focused onto the NNR.

### BACKGROUND OF THE INVENTION

1. Field of the Invention

The present invention relates to a system for bar-code/character/graph reader, which can read bar-codes, characters, and graphs, and more particularly, for a wireless bar-code/character/graph reader using Neuron-Network-Retina (NNR) as an optical input device to convert image into electrical signals for further processing.

2. Background of the Invention

I. Neuron-Network Retina

The analysis and modeling of human neural system has long been a very important research field. It is known that a human brain may consist of ˜10¹¹ neurons with over ˜10³ interconnections per neuron, which performs dedicated functions in a highly parallel processing manner. For example, the retina in human eyes contains millions of cells, which can perform many functions for image processing, such as image sensing, smoothing, feature extraction, and dynamical processing. The retina is the early processing element in the visual nervous system. It performs three major functions in image processing, i.e., photoinput sensing, edge extraction, and moving-object extraction, and then sends out suitable signals to the brain.

With the progress in semiconductor IC technologies, neural networks can now be made artificially. One compact and efficient way to realize an artificial retina is to integrate a large number of microelectronic or nanoelectronic devices in a microchip to form a “silicon retina”, or so-called neuron-network-retina (NNR). Thus, many artificial neurons or cells can be implemented within a reasonable size of microchip to achieve the same dedicated neural functions done in the human retina. The NNR is commonly in the form of two-dimensional array, which can be formed by, for example, an array of bipolar junction transistors (BJTs) with the same base region by the state-of-the-art IC technology. Therefore, the NNR is also called as BJT-based Silicon Retina or Neural Seneor-Silicon Retina.

The NNR can be considered as a light-sensing device, which can convert an image into electrical signals, similar to the conventional light-sensing devices, such as charge-couple device (CCD) or photodiode array. Further, the NNR is superior to the conventional light-sensing devices due to the fact that the NNR also have many advantages, such as image smoothing, moving-object feature extraction, black/white contrast enhancement, and etc., without the need of any software. Since these dedicated function are done in the same chip, the computation cost can be reduced and the processing speed can be enhanced. Moreover, high-performance real-time processing could be achieved. Therefore, the NNR will be an ideal device for application in image reader, such as bar codes, character and graphics. Due to the advantages of the NNR as mentioned above, when NNR is applied to a bar-code/character/graph reader, it can remove possible error causing by shadow, scanning speed difference, dirty image (from a fax copy, for example), tilt angle, etc . . .

II. Bar-Code Reader

There are currently four different types of bar-code readers available. Each of them uses a slightly different technology for reading and decoding a bar code. There are LCD readers (i.e. bar-code wands), laser scanners, CCD readers and camera-based readers.

A. LCD Readers and Laser Scanners

LCD readers consist of a light source and a photo diode that are placed next to each other in the tip of a pen or a wand. To read a bar code, one has to drag the tip of the pen across all the bars in a steady even motion. The photo diode measures the intensity of the light reflected from the bar code and generates a waveform that is used to measure the widths of the bars and spaces in the bar code. Dark bars in the bar code absorb light and white spaces reflect light so that the voltage waveform generated from the photo diode is an exact duplicate of the bar and space pattern in the bar code. This waveform is decoded by the scanner in a manner similar to the way of decoding Morse code dots and dashes.

Laser scanners work in the same way as the LCD readers except that they use a laser beam as a light source and typically employ either a reciprocating mirror or a rotating prism to scan the laser beam back and forth across the bar code. Just the same as the LCD reader, a photo diode is used to measure the intensity of the laser light reflected from the bar code. In both pen readers and laser scanners, the light emitted by the reader is modulated by a specific frequency and the photo diode is designed to detect only the light of the same frequency. LCD readers and laser scanners can be purchased with different resolutions, in order to enable them to read bar codes of different sizes. The scanner resolution is also limited by the spot size of the light emitted from the reader. The size of the light spot should be equal to or slightly smaller than the narrowest element width (“X” dimension). If the spot is wider than the width of the narrowest bar or space, the light spot will overlap two or more bars at a time and thereby causing the transitions between bars and spaces indistinguishable. If the light spot is too small, any spots or voids in the bars can be misinterpreted as light areas, which will also make a bar code unreadable. The most commonly used X dimension is 13 mils (roughly 4 printer dots on a 300 DPI printer). Because this X dimension is so small, it is extremely important that the bar code is created with a program that creates high-resolution graphics (like B-Coder).

B. CCD Readers

CCD (Charge Coupled Device) readers use an array of hundreds of tiny light sensors lined up in a row in the head of the reader. Each sensor can be thought of as a single photo diode that measures the intensity of the light immediately in front of it. Each individual light sensor in the CCD reader is extremely small and because there are hundreds of sensors lined up in a row, a voltage pattern identical to the pattern in a bar code is generated in the reader by sequentially measuring the voltages across each sensor in the row. The important difference between a CCD reader and a pen or laser scanner is that the CCD reader is measuring emitted ambient light from the bar code whereas the LCD reader or the laser scanners are measuring reflected light of a specific frequency generating from the scanner itself

C. Camera-Based Readers

The fourth and newest type of bar code reader currently available is camera-based reader that uses a small video camera to capture a bar code image. The reader then uses sophisticated digital image processing techniques to decode the bar code. Video cameras use the same CCD technology as in a CCD bar code reader except that instead of having a single row of sensors, a video camera has hundreds of rows of sensors arranged in a two dimensional array so that they can generate an image.

The factors that make a bar code readable are: an adequate print contrast between the light and dark bars and having all bar and space dimensions within the tolerances for the symbol. It is also helpful to have sharp bar edges, few or no spots or voids, a smooth surface and clear margins or “quiet zones” at either end of the printed symbol. Interfacing a bar-code reader to a PC is also important. All application programs support bar code reading as long as you have the right equipment. Bar code readers are available with two types of output—either “keyboard wedge” output or RS232 output. The bar code readers with keyboard wedge output plug directly into the keyboard port on your PC and they also provide a pigtail connector so that you can plug in your keyboard at the same time. When you scan a bar code with the keyboard wedge bar code reader, the data goes into the computer just as if it were typed in on the keyboard. This makes it extremely easy to interface the bar code reader to any application that is written to accept keyboard data. The keyboard wedge interface is extremely simple, however it has a few drawbacks. When you swipe a bar code, the cursor has to be in the correct input field and in the correct application, otherwise you end up reading bar code data into whatever application has the focus. This can cause all sorts of potential problems as you can imagine. The keyboard output is also limited, since the data cannot be modified in any way before sending it into the program that is receiving the data. For example, if you needed to parse a bar-code message into multiple pieces or remove a part of a bar code message or add in a date or time stamp, you would not be able to operate with a normal keyboard wedge reader.

The other possible output option is to get a bar code reader with an RS232 or a “Serial” interface. With these types of bar-code readers, one can connect the reader to an available serial port on the back of a PC. A program called a “Software Wedge” is also necessary to take the data from the bar-code reader and feed it into the application where you want the data to go. The disadvantage of this approach is that it is a little more complex, however you gain much more control over how and where the data ends up when you read a bar code.

### SUMMARY OF THE INVENTION

The object of the present invention is to provide a system for bar-code/character/graph reader, which can read bar-codes, characters, and any simple graphs, and more particularly, for a wireless bar-code/character/graph reader using Neuron-Network-Retina (NNR) as an optical input device to convert a bar-code/character/graph image into electrical signals for further processing.

To achieve the object, one embodiment of the invention, takes the following arrangement: The bar-code/character/graph reader is pen-type shaped with NNR located near the tip of said pen. A transparent module and focusing lens is located between the bar-code/character/graph image and the NNR, so that the ambient light will not be blocked, and the image can always be focused onto the NNR. Thus, no dedicated light source such as light emitting diode (LED) is necessary. This can also achieve the purpose of power saving, which plays a critical role for battery operation. The NNR can further be equipped with the ability on the same chip to remove possible error causing by shadow, scanning speed difference, dirty image (from a fax copy, for example), tilt angle, etc . . . The output of NNR can be fed through a Radio Frequency (RF) transmitter for wireless operation, and then transferred into a RF receiver with a few meters away connecting to a personal computer.

### BRIEF DESCRIPTION OF THE DRAWINGS

FIG. 1 is a transparent module of an embodiment of the present invention.

FIG. 2 is an example of a set of bar codes;

FIG. 3 shows how a Neuron-Network-Retina (NNR) in the form of array records a bar-code/character/graph image of the present invention;

FIG. 4A is simulated result of the input current as a function of time for a bar-code/character/graph reader moving in a constant velocity with respect to the bar code;

FIG. 4B is simulated result of the output voltages as a function of time for a bar-code/character/graph reader moving in a constant velocity with respect to the bar code;

FIG. 5A is simulated result of the received photocurrent of the neuron-network retina;

FIG. 5B is simulated result of output image of the neuron-network retina, after equipping with the noise removal capability.

### DETAILED DESCRIPTION OF THE PREFERRED EMBODIMENT

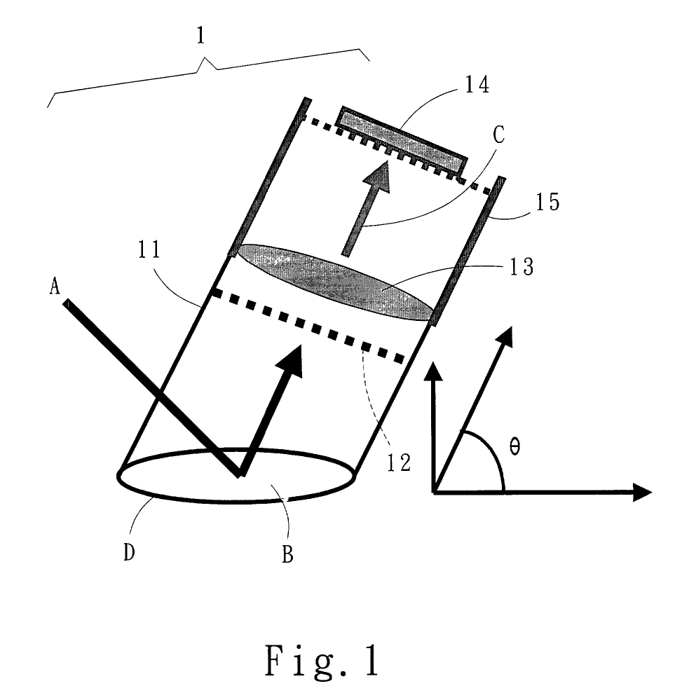

The bar-code/character/graph reader of the present invention comprises a transparent module for collecting bar-code/character/graph images and a Neuron-Network-Retina (NNR) as an optical input device to convert the collected bar-code/character/graph image into electrical signals for further processing. The bar-code/character/graph reader is pen-type shaped with a NNR located near the tip of said pen. The transparent module is located between the bar-code/character/graph image and the NNR so that the ambient light will not be blocked, and the image can always be focused onto the NNR. FIG. 1 shows a schematic diagram for the transparent module (1) of the invented bar-code/character/graph reader. The transparent module (1) contains transparent window (11) of tubular shape, having a specific contact angle θ to the bar-code/character/graph image (B). The ambient light (A) can transmit into the transparent window (11) and reflect from the bar-code/character/graph image (B) on the contact surface (D). The reflected light is optionally passing through a filter (12) and than collected by a focusing lens (13), and the focused image (C) is then feed into the NNR chip (14). The tube (15) between the focusing lens (13) and the image focal plan of the NNR chip (14) should be made of non-transparent materials. Therefore the undesired ambient scattering light can be block-out and the noise level induced by the stray light can be effectively reduced. The main advantage of this design is that the bar-code/character/graph image (B) collected by the transparent module (1) is using the nature ambient light (A), so that no dedicated light source such as light emitting diode (LED) or laser diode (LD) used in LCD readers and laser-scanner-type reader is necessary. Thus the invented bar-code/character/graph reader can achieve the purpose of power saving, which is very critical for battery operations.

It should be mentioned that the use of NNR is only a preferred embodiment of the present invention, the NNR can be replaced by other devices to convert image signals into electrical signals for further processing, such as CCD or photodiode array, etc . . . But CCD or photodiode array still need additional signal processing unit, and additional softwares/firmware to achieve the same job done by NNR single chip.

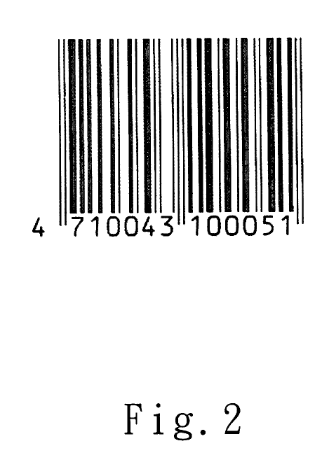

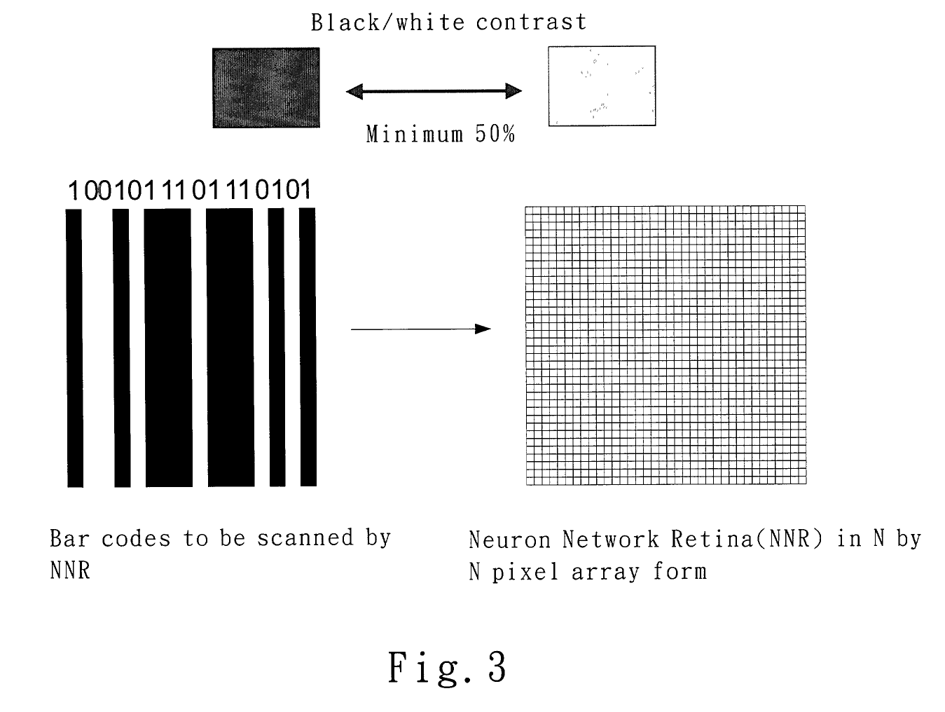

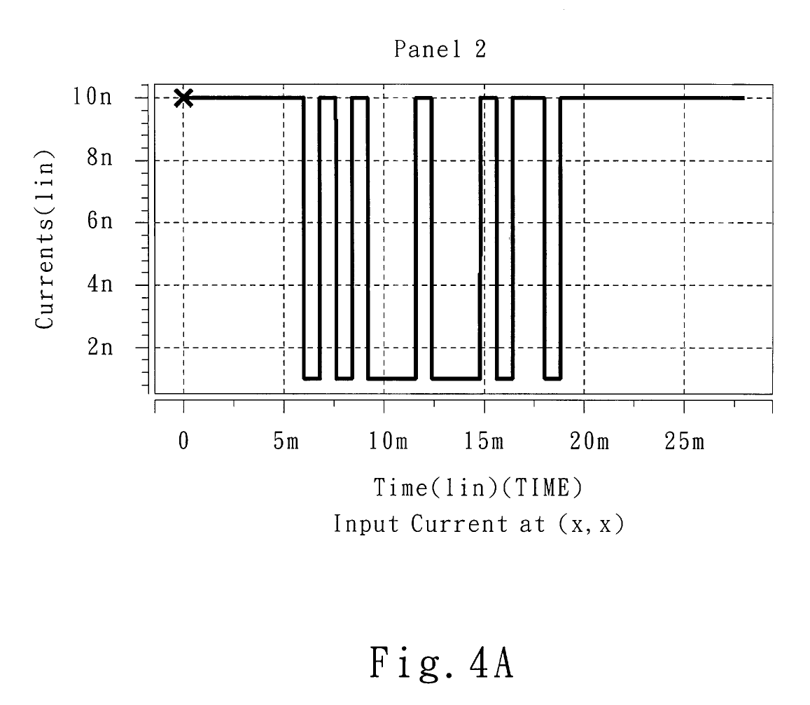

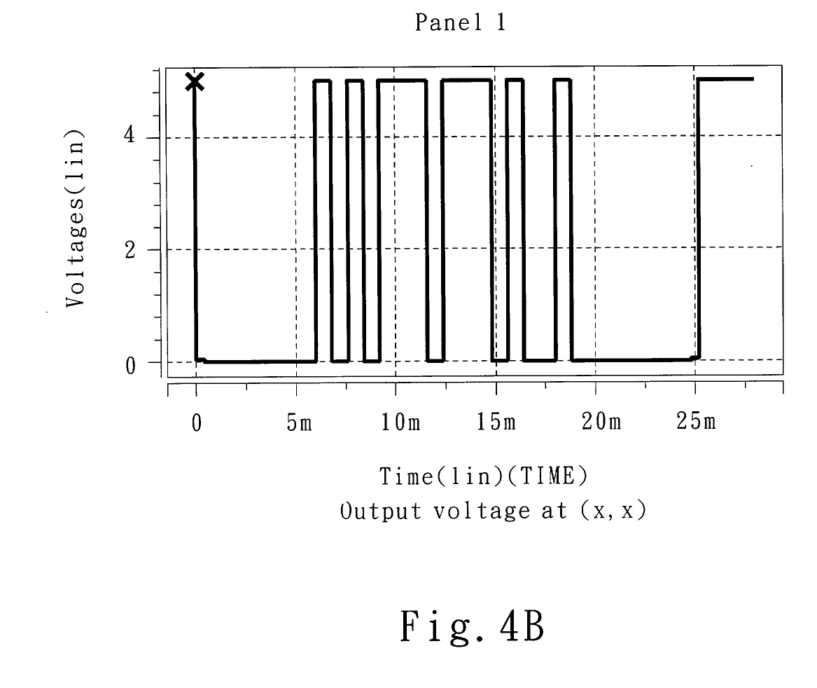

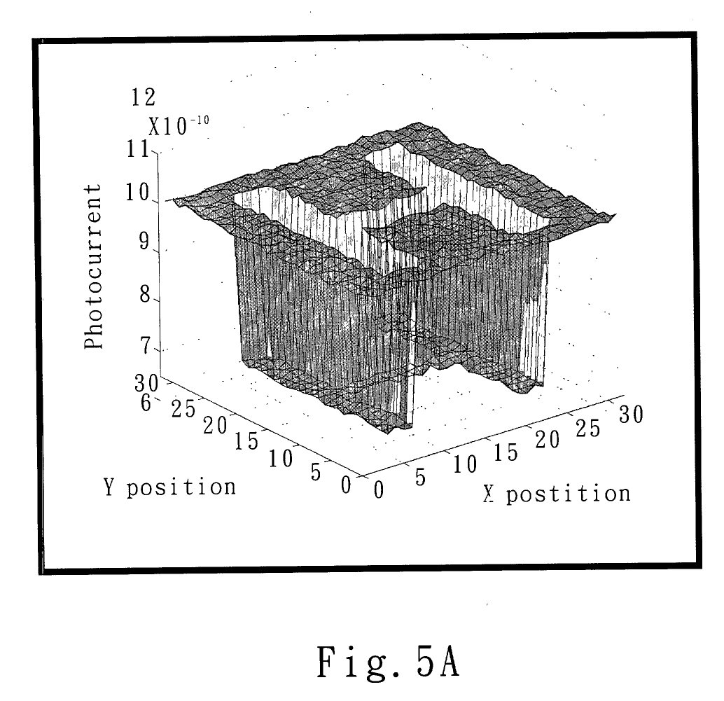

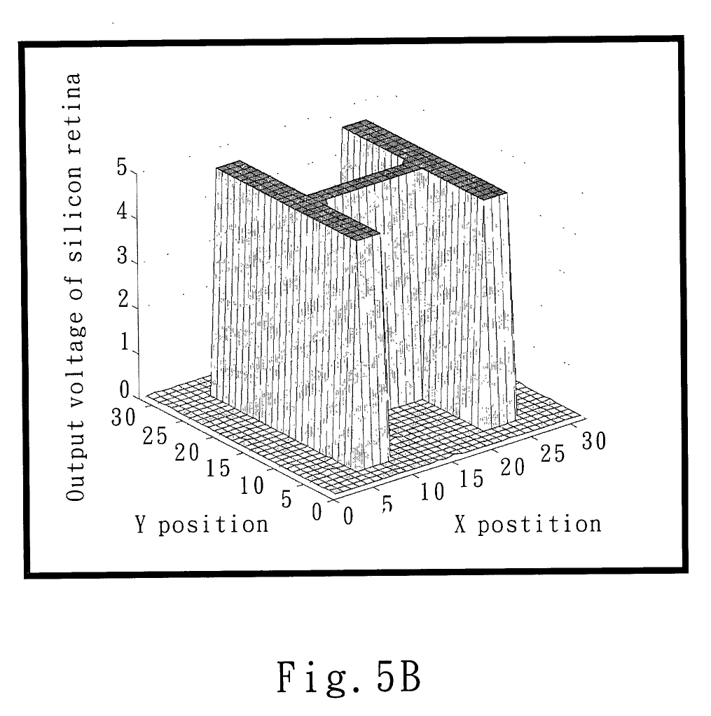

A typical bar-code image is shown in FIG. 2. The black bar and white bar stands for the logic value of “1” and “0”, respectively. As depicted in FIG. 3, the pixel size of the NNR is designed to be at least 2 times smaller than the bar-code width, so that the bar-code image can be well resolved by the NNR. In FIG. 4A and FIG. 4B, we shows the simulated results of the input current and the output voltages as a function of time for a bar-code reader moving in a constant velocity with respect to the bar code, respectively. It clearly demonstrates the performance of moving-object feature extraction of a NNR. The noise removal capability of the NNR is displayed in FIG. 5A and FIG. 5B. It is noted that the noisy photocurrent received from the NNR can be converted to a clear image of sharp contrast and well-defined edge. The invented NNR bar-code/character/graph reader can be equipped with a radio-frequency (RF) transmitter module, forming a system of wireless bar-code/character/graph reader. The RF module comprises an RF transmitter and an RF receiver connecting to a personal computer. The output of NNR is fed through the RF transmitter, then transferred into a RF receiver with a few meters away, and finally sent into a PC for bar-code/character/graph decoding.

What is claimed is:

1. A bar-code/character/graph reader, comprising
a transparent module for bar-code/character/graph image collection;
a means for converting images into electrical signals and operate in cooperation with said transparent module such that bar-codes, characters. and any simple graphs can be read by the bar-code/character/graph reader;
a main body with integrated circuits for signal processing.

2. A bar-code/character/graph reader as described in claim 1, where in the said transparent module further comprises
a transparent window for collecting ambient light source;
a lens for focusing the collected bar-code/character/graph image;
a non-transparent tube for blocking out the undesired stray light.

3. A bar-code/character/graph reader as described in claim 2, where in the said transparent window further comprises a certain angle of contact to surface containing bar-code/character/graph image.

4. The said means as described in claim 1 is a neuron network retina (NNR) for converting a bar-code/character/graph image into electrical signals.

5. The said means as described in claim 1 is a charge-couple device (CCD) reader with additional signal processing unit, and additional software/firmware.

6. The said NNR as described in claim 4 is in the form of array with built-in light sensing device for bar-code/character/graph image receiving and converting the received optical signals into electrical signals.

7. The said NNR as described in claim 4 further comprises noise removal, edge extraction, and movement capturing capability.

8. A bar-code/character/graph reader as described in claim 1, where in the said main body further comprises a battery to provide a main power of the bar-code/character/graph reader for battery operation.

9. A bar-code/character/graph reader as described in claim 1, where in the said transparent module, the said means and the said main body are integrated in pen-shaped form.

10. A system of wireless bar-code/character/graph reader, comprising:
a transparent module for bar-code/character/graph image collection;
a neuron network retina device for converting images into electrical signals and operate in cooperation with said transparent module such that bar-codes, characters, and any simple graphs can be read by the bar-code/character/graph reader;
a main body with integrated circuits for signal processing;
a radio-frequency (RF) module for transmitting wireless signals.

11. A system of wireless bar-code/character/graph reader as described in claim 10, where in said transparent module further comprises
a transparent window for collecting ambient light source;
a lens for focusing the collected bar-code/character/graph image;
a non-transparent tube for blocking out the undesired stray light;

12. A system of wireless bar-code/character/graph reader as described in claim 11, where in the said transparent window further comprises a certain angle of contact to surface containing bar-code/character/graph image.

13. A system of wireless bar-code/character/graph reader as described in claim 10, wherein the said NNR is in the form of array with built-in light sensing device for bar-code/character/graph image receiving and converting the received optical signals into electrical signals.

14. A system of wireless bar-code/character/graph reader as described in claim 10, wherein the said NNR further comprises noise removal, edge extraction, and movement capturing capability.

15. A system of wireless bar-code/character/graph reader as described in claim 10, where in the said main body further comprises a battery to provide a main power of the bar-code/character/graph reader for battery operation.

16. A system of wireless bar-code/character/graph reader as described in claim 10, where in the said RF module further comprises
an RF transmitter implanted in the main body of the bar-code/character/graph reader;
an RF receiver connected to a personal computer for data recording.

17. A system of wireless bar-code/character/graph reader as described in claim 10, where in the said transparent module, the said NNR, the said main body and the said RF module are integrated in pen shaped form.
